(19) United States
(12) Patent Application Publication
(10) Pub. No.: US 2006/0061052 A1
(43) Pub. Date: Mar. 23, 2006

(54) Asymmetric snowmobile ski

(75) Inventor: Rene Lemieux, Granby (CA)

Correspondence Address: OSLER, HOSKIN & HARCOURT LLP (BRP), 2100 - 1000 DE LA GAUCHETIERE ST. WEST, MONTREAL, H3B4W5, CA

(73) Assignee: Bombardier Recreational Products Inc., Valcourt (CA)

(21) Appl. No.: 11/229,679

(22) Filed: Sep. 20, 2005

Related U.S. Application Data
(60) Provisional application No. 60/610,947, filed on Sep. 20, 2004.

(51) Int. Cl. B62B 19/00

(52) U.S. Cl. 280/28

(57) ABSTRACT

A snowmobile ski has a base with dominant and outrigger keels integrally formed therewith. Runners are disposed on the bottoms of the keels. The dominant keel is disposed on the center line of the ski, while the outrigger keel is disposed adjacent to one outer lateral edge of the ski and corresponding snowmobile. Consequently, the keels are asymmetrically disposed relative to the center line. A substantially flat floatation area is disposed on a bottom surface of the base on an opposite side of the dominant keel from the outrigger keel. The asymmetrical positioning of the keels and floatation area improves the ski's handling characteristics.

### BACKGROUND OF THE INVENTION

This application claims priority to U.S. Provisional Application Ser. No. 60/610,947, filed on Sep. 20, 2004, which is incorporated herein by reference in its entirety.

### FIELD OF THE INVENTION

This invention relates to a snowmobile ski, and particularly to a snowmobile ski that is designed to improve the ski's handling characteristics.

### DESCRIPTION OF RELATED ART

In designing snowmobile skis, there are several important performance criteria. These include, inter alia, maneuverability, steerability, stability, floatation, and side-hilling characteristics. “Maneuverability” is also referred to as “aggressivity” in the industry and describes the ability of the skis to effectively handle and steer the sled in response to the turning of the steering bar of the snowmobile. “Steerability” refers to the relative ease with which the sled can be steered with the skis. By definition, a set of skis is easy to steer when the resistance to the steering is kept minimal. “Stability” addresses the pitching and darting tendency of the snowmobile skis during the ride. Rather than being aligned in the intended direction without much wavering, snowmobile skis may pitch and dart, thereby requiring frequent adjustments of the steering system in order to steer the skis and the sled in the intended driving direction. “Floatation” refers to the performance of the skis on powder snow (as opposed to compact trails or ice). A ski with superior floatation characteristics will support more of the snowmobiles weight and prevent the ski from sinking further into the snow thus enabling the snowmobile to move forward with less difficulty. In such applications as mountain snowmobiles, superior floatation characteristics are essential, as the snowmobile will often be driven on deep fresh powder snow. Finally, “side-hilling capability” refers to the performance of the snowmobile skis, typically on mountain snowmobiles, when the sled climbs a hill by traversing diagonally up the hill in a zigzag fashion. In side-hilling, the snowmobile is tilted in the direction of the turn, and as a result, the ski on the tilted side tends to be relied upon more heavily than the ski on the other side during each turn. In instances where the skis have poor side-hilling capabilities, the ski/snowmobile may slip laterally because not enough snow is engaged by the skis when tilted on one side.

Depending on the intended application of a snowmobile, the particularities of the designs of the snowmobile skis or the methods of attaching the skis to the snowmobile can be varied so as to balance the desired performance characteristics of the skis. Indeed, prior patents illustrate numerous examples of attempts to improve and/or balance these desirable characteristics in snowmobile skis (see, e.g., U.S. Pat. Nos. 3,645,347, 5,443,278, 6,267,392, and 6,692,009). There remains a need in the art for a snowmobile ski with improved handling characteristics.

### SUMMARY OF THE INVENTION

Accordingly, one aspect of one or more embodiments of this invention provides a snowmobile ski with improved floatation for use in powder snow applications, which is generally beneficial for mountain snowmobiles, and improved aggressivity and steerability for trail applications, which are desirable for touring snowmobiles.

Another aspect of one or more embodiments of this invention provides a snowmobile ski with improved handling and steering performance.

Another aspect of one or more embodiments of this invention provides a snowmobile ski with improved maneuverability, stability, steerability, floatation and side-hilling characteristics.

Another aspect of one or more embodiments of this invention provides a snowmobile ski that includes a longitudinal base having a top surface adapted to be connected to a snowmobile and a bottom surface. The base has a longitudinal center line and a width that extends between a first edge and a second edge. The top surface is adapted to be connected to a bridge. The ski also includes a plurality of keels extending from the bottom surface. The plurality of keels are disposed asymmetrically with respect to one of the longitudinal center line of the base and a longitudinal center line of the bridge. A runner is disposed on a bottom of each of the keels.

According to a further aspect of one or more of these embodiments, each of the plurality of keels is integrally formed with the base.

According to a further aspect of one or more of these embodiments, the bottom surface of the base is substantially smooth beneath the second edge.

According to a further aspect of one or more of these embodiments, the snowmobile ski is a two-keeled ski.

According to a further aspect of one or more of these embodiments, one of the plurality of keels is disposed at or near the center line of the base. The one of the plurality of keels may extend downwardly farther than any other one of the plurality of keels.

According to a further aspect of one or more of these embodiments, the. keels may include a generally dominant keel at the center line of the base, and a secondary keel spaced from the center line. One or more of the keels may be integrally formed with the base.

According to a further aspect of one or more of these embodiments, the bottom surface of the base is substantially smooth between the dominant keel and the second edge. The floatation area may be a substantially smooth surface.

According to a further aspect of one or more of these embodiments, the first edge is disposed at an outer edge with respect to a snowmobile.

According to a further aspect of one or more of these embodiments, the second keel is disposed closer to the first edge than the first keel, and the bottom surface defines a channel between the first and second keels.

According to a further aspect of one or more of these embodiments, the ski includes a bridge connected to the top surface of the base. The bridge is adapted to connect to a ski leg of a snowmobile.

According to a further aspect of one or more of these embodiments, the ski is combined with a snowmobile such that the top surface of the base is operatively connected to the snowmobile.

According to a further aspect of one or more of these embodiments, the bottom surface forms a channel between the first and second keels for the passage of snow. The channel is disposed to one side of the longitudinal center line. A free edge is disposed to the other side of the longitudinal center line. The channel may be concave.

Additional and/or alternative advantages and salient features of embodiments of the invention will become apparent from the following detailed description, which, taken in conjunction with the annexed drawings, disclose preferred embodiments of the invention.

### BRIEF DESCRIPTION OF THE DRAWINGS

Referring now to the drawings which from a part of this original disclosure:

FIG. 1 is a perspective view, from the bottom, rear side, of a snowmobile ski according to one embodiment of the present invention;

FIG. 2 is a front plan view thereof;

FIG. 3 is a cross-sectional view thereof, taken along the line 3-3 in FIG. 4;

FIG. 4 is a left side elevation view thereof;

FIG. 5 is a right side elevation view thereof;

FIG. 6 is a bottom plan view thereof;

FIG. 7 is a left side elevation view of a second embodiment according to the present invention;

FIG. 8 is a cross-section view taken along 8-8 in FIG. 7; and

FIG. 9 is a side elevation view of a snowmobile equipped with the ski according to the present invention.

### DETAILED DESCRIPTION OF PREFERRED EMBODIMENTS

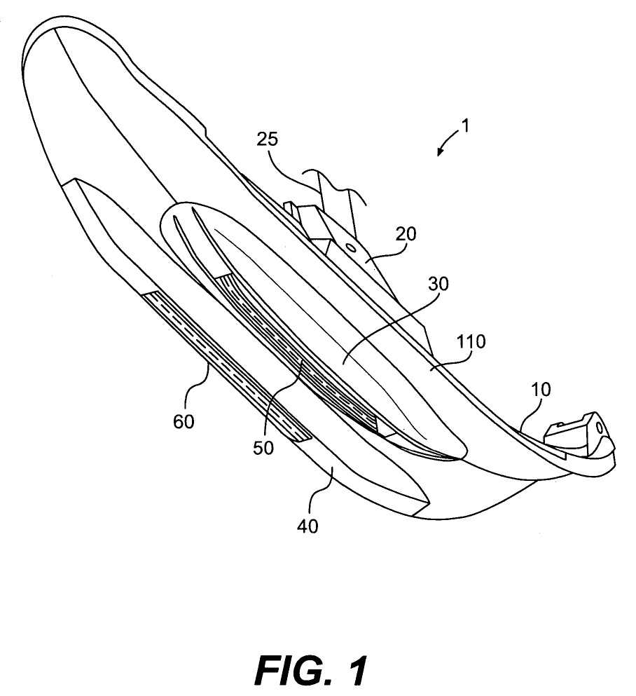

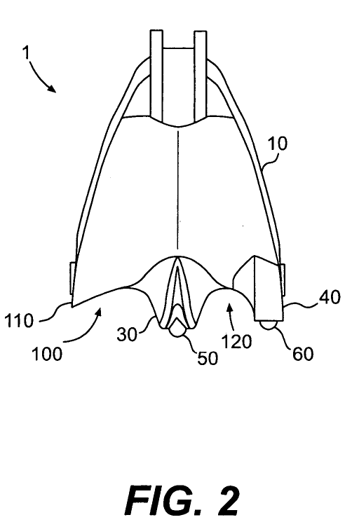

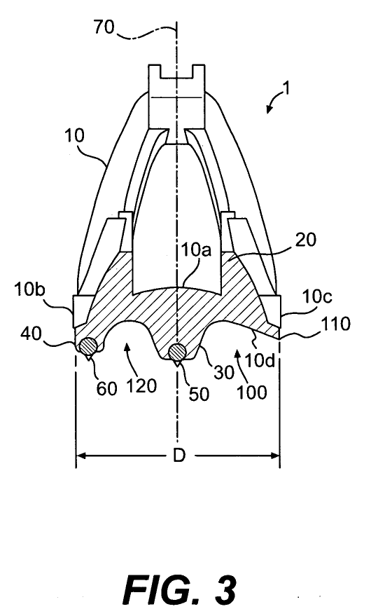

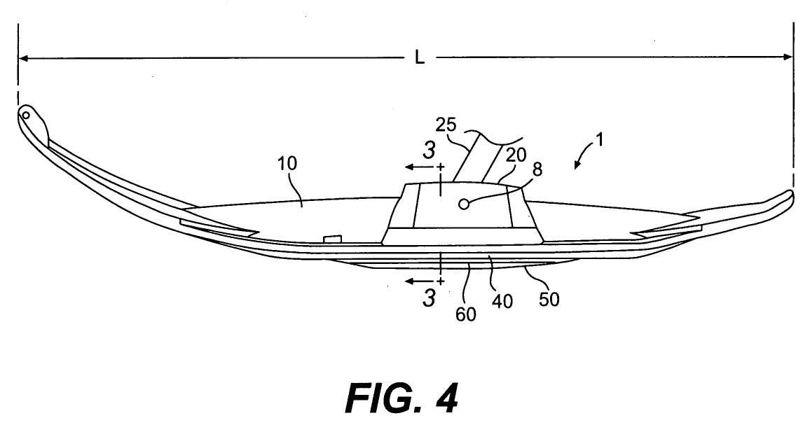

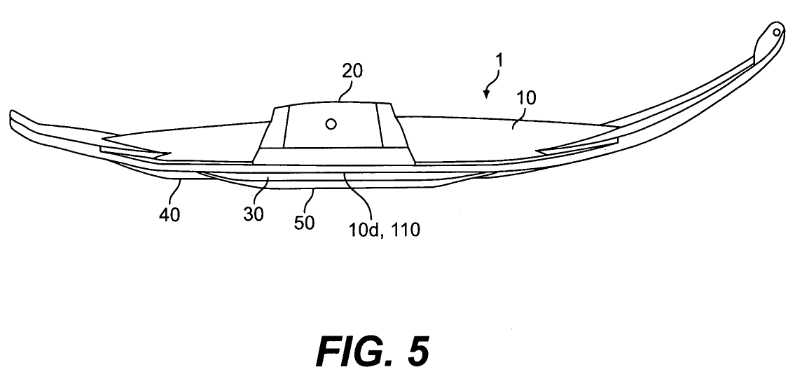

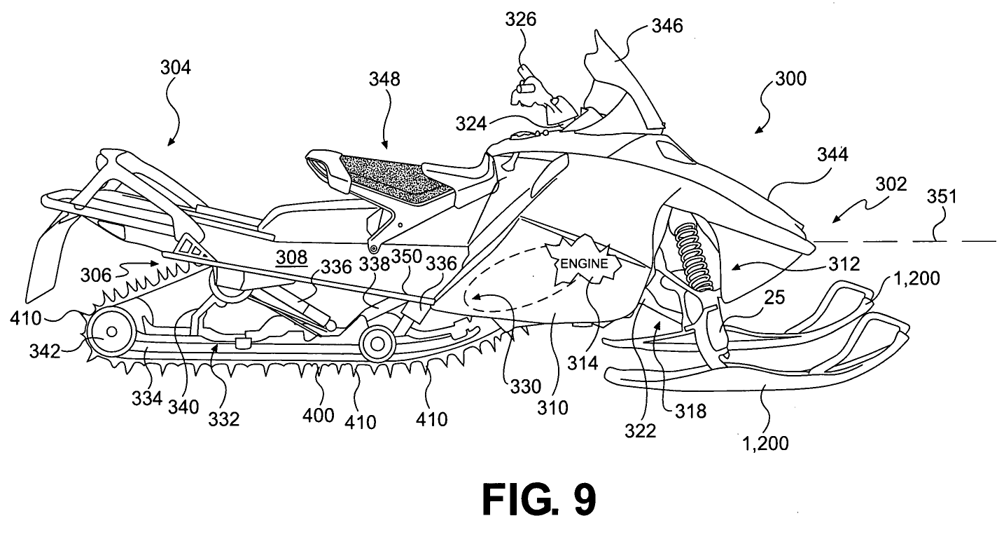

FIGS. 1-6 illustrate a snowmobile ski 1 according to one embodiment of the present invention. As shown in FIGS. 1 and 3, the ski 1 comprises a base 10, a bridge 20 mounted to the base 10, a dominant keel 30, an outrigger keel 40, a dominant runner 50, and an outrigger runner 60. As shown in FIG. 1, the bridge 20 operatively connects the ski 1 to a leg 25 of a snowmobile 300 as shown in FIG. 9.

The base 10 is preferably molded from a strong, light material such as high density polyethylene (HDPE) or ultra high molecular weight plastic (UHMW), but may alternatively be constructed in any suitable manner from any suitable material(s) (e.g., steel, aluminum, PVC, etc.). As shown in FIG. 3, the base 10 defines a top surface 10a, lateral edges 10b, 10c, and a bottom surface 10d. The base 10 defines a longitudinal center line 70 that is disposed halfway between the lateral edges 10b, 10c. The lateral edges 10b and 10c are the outermost lateral portions of the ski 1. The edges 10b and 10c define the side walls of the base 10, in this case, as they extend substantially vertically with respect to the base 10. However, it may be desirable to have the side walls flare outwardly or taper inwardly with respect to an edge. The total floatation area 100 of the ski 1 is defined by projecting the ski onto the snow when looking vertically downward at the ski from above. In this case, the floatation area 100 of ski 1 is determined by integrating the equation of a line following the lateral edges 10b and 10c over the overall length L of ski 1.

It is thus to be understood that the floatation area 100 of the ski 1 also includes keels 30, 40 and runners 50, 60 and bottom surface 10d as these elements will, in certain conditions, create a certain amount of floatation. For example, if the snow is relatively hard, keels 30, 40 and runners 50, 60 generally contact the hard snow. Those surfaces can receive sufficient reaction forces from the snow so that the snowmobile can sustain stable running conditions when proceeding straight ahead or turning right or left.

If the snow is shallow and relatively soft, the ski 1 can be partially buried under the snow. That is, keels 30, 40; runners 50, 60 as well as at least some part of the bottom surface 10d is likely to be below a top surface of the snow and receive reaction forces from the snow to sustain stable running conditions both when proceeding straight ahead or turning right or left.

However, If the snow is deep and relatively soft, the ski 1 is most likely to be entirely buried under the snow thus the keels 30, 40; runners 50, 60 and the entire bottom surface 10d will contribute in creating the floatation surface and sustain stable running conditions both when proceeding straight ahead or turning right or left.

As shown in FIG. 3, the bridge 20 is integrally formed with the base 10, which preferably comprises a strong, light material such as aluminum, PVC, HDPE, etc. The top surface 10a of the base 10 is connected to the bridge 20 through integral formation, such as molding. Alternatively, a discrete bridge may mount to the top surface 10a of the base 10 via a suitable fastener such as bolts, glue, etc. The longitudinal center line 70 of the base 10 is also a longitudinal center line of the bridge 20. However, the bridge 20 could alternatively be laterally offset relative to the center line 70, for example as is shown in U.S. Pat. No. 6,692,009, without deviating from the scope of the present invention.

As shown in FIG. 3, the keels 30, 40 extend downwardly from the bottom surface 10d of the base 10. In the illustrated embodiment, the keels 30, 40 are integrally formed with the base 10 such that the bottom surface 10d defines the keels as well. However, the keels 30, 40 may alternatively be formed in the base 10 or may be distinct from the base 10 and fastened to the base 10 using any suitable fastener (e.g., over molding, bolts, screws, glue, welding, cotter pins, etc.).

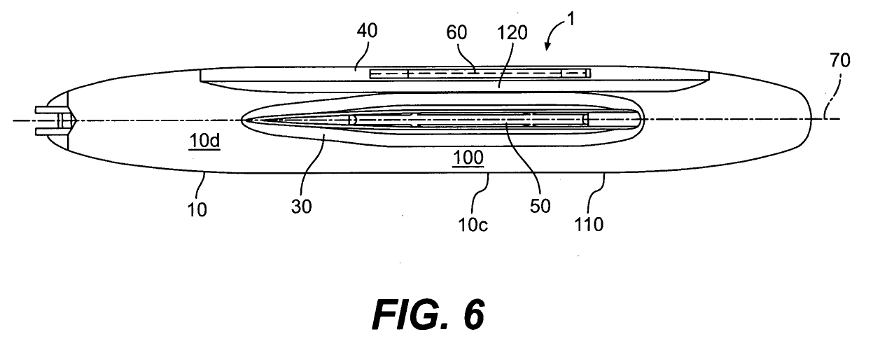

Each of the keels 30, 40 has a curvature so that the keel 30 or 40 slopes gradually from the bottom surface 10d to a lower running surface intended to engage the runners 50, 60. As seen in FIG. 6, the dominant keel 30 is shorter and protrudes more deeply from the bottom surface 10d. The outrigger keel 40 is longer and extends from a front portion to a rear portion of the ski 1 and protrudes downwardly less than the dominant keel 30. It is contemplated that the outrigger keel 40 be equal in length to the dominant keel 30.

As shown in FIG. 3, the dominant keel 30 is disposed at the center line 70 of the base 10 to provide equal floatation areas on both sides. If the bridge 20 was offset from the center line 70, the dominant keel 30 could alternatively be disposed at a center line of the offset bridge without deviating from the scope of the present invention. Alternatively, the dominant keel 30 may be offset from the center line 70 of the base 10 and bridge 20 without deviating from the scope of the present invention.

As shown in FIG. 3, the outrigger keel 40 is disposed adjacent to (i.e., at or near) the lateral edge 10b of the base 10. In the illustrated embodiment, the edge 10b defines a longitudinal side portion of the base 10 as described above. An outer edge of the outrigger keel 40 is coextensive with the longitudinal side portion of the base 10. The outrigger keel 40 may alternatively be spaced inward from the lateral edge 10b or have a side wall that tapers or flares with respect to the edge 10b without deviating from the scope of the present invention. In any event, the dominant keel 30 extends downwardly farther than the outrigger keel 40.

As shown in FIG. 3, the keels 30, 40 have runners/skags 50, 60 fastened to the bottoms of the keels 30, 40, respectively, in any suitable manner. The runners 50, 60 preferably comprise hard metal guide rods that are resistant to wear. The runners 50, 60 also optionally include carbide edges that are designed to bite into ice to improve the ski's steering performance. The central runner 50 extends downwardly farther than the outrigger runner 60, with respect to the base 10.

As shown in FIGS. 3 and 6, the bottom surface 10d between the dominant keel 30 and the lateral edge 10c defines a substantially smooth portion of the floatation area 100. As shown in FIG. 3, the portion of the floatation area 100 between the dominant keel 30 and the lateral edge 10c may nonetheless includes minor concavities, convexities, and angles due to the formation. Consequently there is no channel with defined edges in the floatation area 100.

As shown in FIG. 3, the intersection of the bottom 10d and lateral edge 10c of the base 10 defines a rib 110. The rib 110 helps the floatation area 100 to compact snow to further improve floatation. The rib 110 is not to be considered a keel because the rib does not and could not include a runner mounted to it, as in the keels 30, 40.

As shown in FIGS. 3 and 6, the bottom surface 10d forms a channel 120 between the keels 30, 40. In the illustrated embodiment, the channel 120 has an asymmetrical, curved U-shape, but could alternatively form a variety of other channel shapes (e.g. rectangular, polygonal, or otherwise angled channel, etc.) without deviating from the scope of the present invention. The channel 120 has a concavity that is larger than a concavity of the substantially smooth floatation area 100 on an opposite side of the dominant keel 30. The outrigger keel 40, as well as the outrigger runner 60, extend farther downward than any portion of the ski 1 on an opposite side of the dominant keel 30.

Throughout this description, all heights are measured relative to a horizontal plane that extends through pivotal point 8 between the bridge 20 and the leg 25 and is measured when the ski 1 is resting on level ground.

The keels 30, 40 of ski 1 are preferably asymmetrically offset toward an outer lateral edge of the snowmobile. Consequently, the keel 40 is disposed closer to the outer lateral edge of the snowmobile than in conventional laterally-symmetrical skis. For example, the ski 1 includes keels 30, 40 that are asymmetrically offset such that the outrigger keel 40 is disposed adjacent to the lateral edge 10b of the base 10. The ski 1 is therefore well suited for use as a left snowmobile ski so that the lateral edge 10b and outrigger keel 40 are disposed at an outer edge of the snowmobile. A corresponding right ski would be a mirror image of the left snowmobile ski 1.

Such outward positioning of the outrigger keel 40 enhances the snowmobile's handling characteristics. In particular, it is known that when turning a snowmobile while travelling at low speeds, there is little, if any, additional weight transferred to the outside ski. Due to the difference in height of the keels 30, 40, only keel 30 will be in contact with the ground to provide turning. It is also known that at low speeds, in order to decrease the force required to turn the skis, the length of the keel is to be kept to a minimum. The downfall of having a short keel is that at high speeds, the shorter keel will not provide sufficient bite thus the ski will simply be pushed over the snow not accomplishing the desired result of changing the direction of the snowmobile even though the ski is turned in the desired direction. The present invention provides a short dominant keel 30, which will reduce the amount of force required to turn the ski 1 at low speeds. It also provides the outrigger keel 40 and runner 60 such that at high speeds, when there is additional weight transferred to the outside ski while turning, causing the skis to tilt about centerline 70, thus engaging the outrigger keel 40 with the ground, the combined bite of the short dominant keel 30 and the outrigger keel 40 provides an aggressive ski for turning the vehicle at high speeds. Conversely, the outrigger keel 40 and runner 60 move relatively higher when the ski 1 returns to a straight forward position such that the outrigger keel 40 and runner 60 create less ground friction.

When side hilling, the outrigger keel 40 of the ski furthest up the hill, creates an additional snow compacting zone between itself and the dominant keel 30 in addition to the compacting zone created between lateral edge 10c and the dominant keel 30 thus creating a plow effect preventing lateral sliding of the ski down the hill.

Yet another advantage of having a raised outrigger keel 40 is while travelling over hard compacted surfaces or ice. In such situations, any surface in contact with the ground which is not in alignment with the leg 25, will provide a moment force about the leg 25 and thus pull the ski away from its forward travelling direction. In order for the elevated outrigger keel 40 of the present invention to make contact with the ground, the snow must be soft enough for the ski 1 to sink beyond the dominant keel 30 and bring outrigger keel 40 in contact with the snow. While in these relatively soft or powdery snow conditions, there is very little friction force between the snow and the keels thus the moment created about the leg 25 by the friction force between the outrigger keel 40 and the snow will be negligible and will have little effect on the forward traveling direction of the ski.

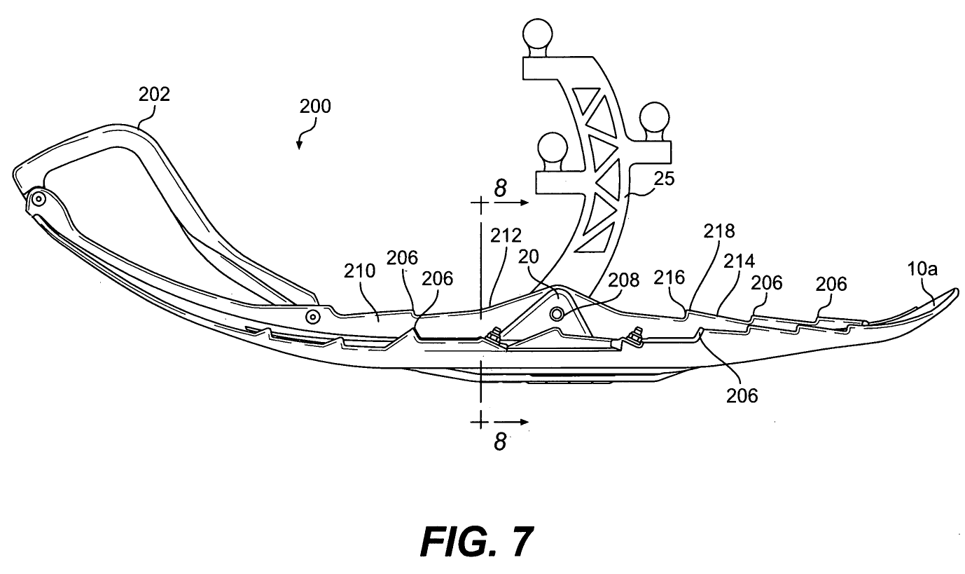

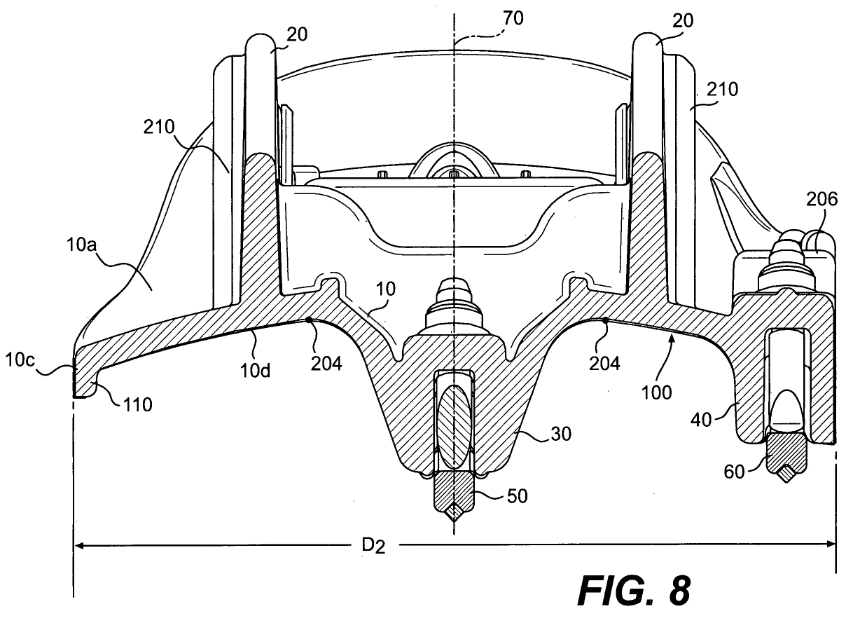

A second embodiment of the present invention is shown in FIGS. 7 and 8. Ski 200 is similar to ski 1 in that it has a base 10 with a central dominant keel 30 and an outrigger keel 40 along its bottom surface 10d. Ski 200 has a top surface 10a with an integrally molded bridge 20 adapted to attached the ski 200 to leg 25. A handle 202 is also fixed to the top surface 10a of the ski 200.

As described above with respect to ski 1, the bottom surface 10d of ski 200 extends between lateral edges 10c and 10b, which define a width D2. Floatation surface 100 extends from lateral edge 10c to lateral edge 10b and includes keel 30, 40, runners/skags 50 and 60 as well as rib 110. As described above with respect to ski 1, the total floatation area can be found by projecting the ski onto the ground.

Dominant keel 30 of ski 200 is preferably symmetric about centerline 70 between points 204 of the bottom surface 10d. Beyond points 204, toward lateral edges 10c and 10b, the bottom surface 10d is asymmetric about centerline 70.

To maintain the advantages mentioned above with respect to the moment created about leg 25 when traversing compact snow or ice, dominant keel 30 extends below outrigger keel 40.

With reference to FIG. 7, ski 200 further includes several anti-slip projections 206. These projections 206 are preferably integrally formed into the top surface 10a of the ski 200 so as to create grips or points that will contact the sole of a boot and prevent the boot from slipping over the top surface 10a of the ski.

In some cases, a snowmobile user will apply pressure to the top surface 10a of the ski 200 using their boot in order to help upright a canted snowmobile. Conventional skis have top surfaces that are relatively smooth along its longitudinal direction thus when pressure is applied to the top portion of the ski, the boot simply slides off.

In the preferred embodiment, the anti-slip projections 206 are slightly angled so as to point toward leg 25 such that when pressure is applied to the top surface 10a of the ski 200, in front of or to the rear of leg 25, and ski 200 pivots about axis 208, the projections 206 will remaining pointing in a direction which prevents the boot from slipping longitudinally along top surface 10a.

Best seen in FIG. 7, ski 200 is provided with a plurality of anti-slip projections 206 in front of as well as to the rear of leg 25. In the preferred embodiment, a longitudinally extending reinforcement rib 210 extends along the top surface 10a of ski 200, the anti-slip projections 206 are formed in the top edge 212 of the rib 210. Other anti-slip projections 206 are provided above the outrigger keel 40.

The preferred shape of the anti-slip projects 206 is to have a first surface 214 angled upwardly toward the pivot axis 208 followed by a second surface 216 angle downward such that a point 218 is created between the two surfaces. The angle and length of surfaces 214 and 216 can be varied in order to vary the aggressiveness of the projection.

The skis 1 and 200 are two-keeled skis. However, additional keels may be added without deviating from the scope of the present invention.

Referring now to FIG. 9, a snowmobile incorporating an embodiment of the present invention is designated generally by reference numeral 300. Although certain aspects of the present invention are applicable in other types of tracked vehicles, the present invention has particular utility in connection with snowmobiles.

The snowmobile 300 includes a forward end 302 and a rearward end 304 which are defined consistently with a travel direction of the vehicle. The snowmobile 300 includes a frame or chassis 306 which normally includes a rear tunnel 308, an engine cradle portion 310 and a front suspension assembly portion 312. An engine 314, which is schematically illustrated in FIG. 9, is carried by the engine cradle portion 310 of the frame 306. A ski and steering assembly (not indicated) is provided, in which two skis 1, 200 are positioned at the forward end 302 of the snowmobile 300 and are attached to the front suspension assembly portion 312 of the frame 306 through a front suspension assembly 318. The front suspension assembly 318 includes ski legs 25, supporting arms 322 and ball joints (not shown) for operatively joining the respective ski legs 25, supporting arms 322 and a steering column 324. The steering column 324 at its upper end is attached to a steering device such as a handlebar 326 which is positioned forward of a rider and behind the engine 314 to rotate the ski legs 25 and thus the skis 1, 200, in order to steer the snowmobile 300.

An endless drive track 400 is positioned at the rear end 304 of the snowmobile 300. The drive track 400 is disposed generally under the tunnel 308, being connected operatively to the engine 314 through a belt transmission system 330 which is schematically illustrated by broken lines in FIG. 9. Thus, the endless drive track 400 is driven to run about a rear suspension assembly 332 for propulsion of the snowmobile 300. The rear suspension assembly 332 includes a pair of slide rails 334 in sliding contact with the endless drive track 400. The rear suspension assembly 332 also includes one or more shock absorbers 336 which may further include a coil spring (not shown) surrounding the individual shock absorbers 336. Front and rear suspension arms 338 and 340 are provided to attach the slide rails 334 to the frame (chassis) 306. One or more idler wheels 342 are also provided in the rear suspension assembly 332.

At the front end 302 of the snowmobile 300, fairings 344 enclose the engine 314 and the belt transmission system 330, thereby providing an external shell that not only protects the engine 314 and the belt transmission system 330, but can also be decorated to make the snowmobile 300 more aesthetically pleasing. Typically, the fairings 344 include a hood (not indicated) and one or more side panels which can be opened to allow access to the engine 314 and the belt transmission system 330 when this is required, for example, for inspection or maintenance of the engine 314 and/or the belt transmission system 330. In the particular snowmobile 300 shown in FIG. 9, the side panels can be opened along a vertical axis to swing away from the snowmobile 300. A windshield 346 may be connected to the fairings 344 near the front end 302 of the snowmobile 300 or directly to the handlebar 326. The windshield 346 acts as a wind screen to lessen the force of the air on the rider while the snowmobile 300 is moving.

The engine 314 is a type of internal combustion engine that is supported on the frame 306 and is located at the engine cradle portion 310. The internal construction of the engine 314 may be of any known type, however the engine 314 drives an engine output shaft (not shown) that rotates about a horizontally disposed axis that extends generally transversely to a longitudinal centerline 351 of the snowmobile 300. The engine output shaft drives the belt transmission system 330 for transmitting torque to the endless drive track 400 for propulsion of the snowmobile 300.

A straddle-type seat 348 is positioned atop the frame 306 and extends from the rear end 304 of the snowmobile 300 to the fairings 344. A rear portion of the seat 348 may include a storage compartment or can be used to accommodate a passenger seat (not indicated). Two footrests 350 are positioned on opposite sides of the snowmobile 300 below the seat 348 to accommodate the driver's feet. As shown in FIG. 9, the endless drive track 400 includes a plurality of lugs 410 (also known as profiles, ribs or paddles) protruding from an outer surface of the track 400. The lugs are integrally formed with a base of the track and extend outwardly to enhance traction in deep snow.

The foregoing description is included to illustrate the operation of the preferred embodiments and is not meant to limit the scope of the invention. To the contrary, those skilled in the art should appreciate that varieties may be constructed and employed without departing from the scope of the invention, aspects of which are recited by the claims appended hereto.

What is claimed is:

1. A snowmobile ski, comprising:
a longitudinal base having a top surface adapted to be connected to a snowmobile and a bottom surface, wherein the base has a longitudinal center line and a width that extends between a first edge and a second edge;
keels disposed on the bottom surface, wherein the keels include a generally dominant keel and a single secondary keel integrally formed with the base;
a runner disposed on the dominant keel; and
a runner disposed on the secondary keel.

2. The snowmobile ski of claim 1, wherein the single secondary keel is disposed on the bottom surface asymmetrically with respect to the longitudinal center line of the base

3. The snowmobile ski of claim 1, wherein the dominant keel is disposed on the bottom surface at the longitudinal center line of the base.

4. The snowmobile ski of claim 1, wherein the dominant keel is symmetric with respect to the longitudinal center line of the base.

5. The snowmobile ski of claim 1, wherein the dominant keel is at least partially asymmetric with respect to the longitudinal center line of the base.

6. The snowmobile ski of claim 1, in combination with a snowmobile, wherein the top surface of the base is operatively connected to the snowmobile.

7. A snowmobile ski, comprising:
a longitudinal base having a top surface adapted to be connected to a snowmobile and a bottom surface, wherein the base has a longitudinal center line and a width that extends between a first edge and a second edge;
keels disposed on the bottom surface, wherein the keels include a generally dominant keel extending a first distance from the base, and wherein the keels include a single secondary keel extending a second distance, shorter than the first distance, below the base;
a runner disposed on the dominant keel; and
a runner disposed on the secondary keel.

8. The snowmobile ski of claim 7, wherein the single secondary keel is integrally formed with the bottom surface.

9. The snowmobile ski of claim 7, wherein the dominant keel is disposed at the center line of the base.

10. The snowmobile ski of claim 7, wherein the generally dominant keel is integrally formed with the base and symmetric with respect to the longitudinal center line of the base.

11. The snowmobile ski of claim 7, wherein the generally dominant keel is integrally formed with the base and at least partially asymmetric with respect to the longitudinal center line of the base.

12. The snowmobile ski of claim 7, in combination with a snowmobile, wherein the top surface of the base is operatively connected to the snowmobile.

13. A snowmobile ski, comprising:
a longitudinal base having a top surface adapted to be connected to a snowmobile and a bottom surface, wherein the base has a longitudinal center line and a width that extends between a first edge and a second edge; and
a plurality of keels asymmetrically disposed on the bottom surface of the base, each of the plurality of keels having a runner disposed thereon.

14. The snowmobile ski of claim 13, wherein the plurality of keels are integrally formed with the bottom surface of the base.

15. The snowmobile ski of claim 13, wherein the dominant keel is disposed at the center line of the base.

16. The snowmobile ski of claim 13, wherein the generally dominant keel is integrally formed with the base and symmetric with respect to the longitudinal center line of the base.

17. The snowmobile ski of claim 13, wherein the generally dominant keel is integrally formed with the base and at least partially asymmetric with respect to the longitudinal center line of the base.

18. The snowmobile ski of claim 13, in combination with a snowmobile, wherein the top surface of the base is operatively connected to the snowmobile.

19. A snowmobile ski, comprising:
a longitudinal base having,
a top surface adapted to be connected to a snowmobile,
a bottom surface,
a longitudinal center line, and
a width that extends between a first edge and a second edge;
a first keel defined by the bottom surface integrally molded with the base and extending a first distance therefrom, the first keel adapted to receive a first runner; and
a second keel also defined by the bottom surface integrally molded with the base in parallel relationship to the first keel, the second keel extending a second distance below the base, the second keel adapted to receive a second runner,
wherein the bottom surface of the ski is at least partially asymmetric about the longitudinal center line.

20. The snowmobile ski of claim 19, wherein the first keel is disposed on the bottom surface at the longitudinal center line of the base.

21. The snowmobile ski of claim 19, wherein the first keel is symmetric with respect to the longitudinal center line of the base.

22. The snowmobile ski of claim 19, wherein the first keel is at least partially asymmetric with respect to the longitudinal center line of the base.

23. The snowmobile ski of claim 19, wherein the second distance is shorter than the first distance.

24. The snowmobile ski of claim 19, wherein the bottom surface defines a floatation area that extends laterally outwardly from the longitudinal center line.

25. The snowmobile ski of claim 19, in combination with a snowmobile, wherein the top surface of the base is operatively connected to the snowmobile.
